(19) United States
(12) Patent Application Publication
(10) Pub. No.: US 2006/0013928 A1
(43) Pub. Date: Jan. 19, 2006

(54) Aqueous edible paint composition, method of preparation and kit

(76) Inventors: Joyce A. Steet, Hackettstown, NJ (US); Gale D. Myers, St. Louis, MO (US); Haralambos N. Meggos, Alton, IL (US); Sandra L. Hughes, Crystal City, MO (US); Arun V. Shastry, Neshanic Station, NJ (US); Valeria M. Acquarone, Hackettstown, NJ (US); Thomas M. Collins, Nazareth, PA (US)

Correspondence Address: FITZPATRICK CELLA HARPER & SCINTO, 30 ROCKEFELLER PLAZA, NEW YORK, NY, 10112, US

(21) Appl. No.: 11/168,521

(22) Filed: Jun. 29, 2005

Related U.S. Application Data
(60) Provisional application No. 60/583,848, filed on Jun. 29, 2004.

(51) Int. Cl. A23F 5/00

(52) U.S. Cl. 426/302

(57) ABSTRACT

An aqueous edible paint composition is disclosed which is useful for painting edible substrates, particularly fat-based edible substrates such as chocolate. Also described is a method of making the edible paint and a kit containing the edible paint and edible substrate.

This application claims the benefit of U.S. provisional patent application No. 60/583,848, filed Jun. 29, 2004 and incorporated by reference herein.

### BACKGROUND OF THE INVENTION

1. Field of the Invention

This invention is directed to an aqueous edible paint composition that is useful for painting edible substrates, particularly fat-based edible substrates such as chocolate. Adhering an aqueous edible paint to a fat-based substrate is particularly challenging due to the interfacial tension between these two components which would typically cause the aqueous edible paint to retract away from the fat-based substrate. The invention is also directed to the method of making the edible paint and a kit containing the edible paint and an edible substrate.

2. Related Background Art

There is a continuing demand for comestible novelty products. Consumers often enjoy personally decorating edible products, particularly when the products are associated with a holiday or family celebration. For instance, the dying and decoration of Easter eggs is a well-known holiday tradition. Similarly, the decoration of cakes with icing for birthdays and holidays is well known. A fat-based edible colorant that must be heated prior to application to an edible substrate has also been described. This edible colorant, however, suffers from the need for the consumer to heat the edible colorant to reduce its viscosity prior to application and has limited painting time before it sets up. Such an edible colorant is clearly not conducive to use by young children. Moreover, edible paints that are solvent-based would similarly not be desirable for use by young children due to the unpleasant taste and safety concerns associated with solvents. This makes an aqueous based edible paint the most desirable option for young children to color fat-based substrates. An aqueous edible paint is ideal in terms of safety and ease of use. Aqueous materials, however, are inherently incompatible with application to fat based substrates. Application of a typical aqueous paint to a fat based substrate would retract away from the surface. Without the use of solvents it is difficult to control the surface tension, viscosity and drying time of the aqueous edible paint. Surprisingly, a unique combination of ingredients have been discovered to overcome these problems and deliver an aqueous based, flowable edible paint that covers and adheres to the fat-based substrate.

Accordingly, there is a need for an aqueous edible paint that is readily flowable without the need for heat and that adheres well to an edible substrate without the substantial use of non-aqueous solvents. There is also a need for such an aqueous edible paint having storage stability and a pleasant taste.

### SUMMARY OF THE INVENTION

This invention is directed to an aqueous edible paint composition that is liquid at room temperature and is preferably substantially free of solvents. The aqueous edible paint adheres on the edible substrate to which it is applied. A particularly preferred edible substrate is chocolate.

Another embodiment of the invention is directed to a method of preparing the aqueous edible paint composition. In yet another embodiment, the aqueous edible paint composition is included with an edible substrate, preferably a fat-based edible substrate, to form the kit of the invention.

### DETAILED DESCRIPTION OF THE INVENTION

The aqueous edible paint composition of this invention comprises a film former, an adhesive agent, a plasticizer, an emulsifier, a colorant and a diluent. All of these ingredients as used in the edible paint composition of this invention are edible, i.e., are safe for consumption. The exemplary components described below are not limiting.

The film former is believed to form a continuous matrix over a fat-based substrate to which the edible paint composition is adhered. The film former will generally be present in an amount of about 0.05% to about 10%, preferably about 0.15% to about 6.25%, more preferably about 0.25% to about 2.5%, even more preferably about 0.5% to 2.0%, yet more preferably about 0.5% to about 1.5%, and most preferably 0.75% to about 1.25% by weight of the composition. The most preferred range of the film former provides the optimal balance of film character and paintability of the finished paint. Preferably the film former is selected from cellulose based edible compounds such as carboxymethylcellulose, methylcellulose, hydroxypropyl cellulose, hydroxypropyl methyl cellulose, microcrystalline cellulose, and mixtures thereof.

The adhesive agent is believed to serve as a surface-active ingredient which functions to assist the film to adhere to a fat-based substrate. The adhesive agent will generally be present in an amount of about 0.5% to about 40%, preferably about 0.75 to about 25%, more preferably about 1% to about 10%, even more preferably about 1.5 to about 7.5%, yet more preferably about 2% to about 5%, and most preferably about 3% to about 4% by weight of the composition. The most preferred range of the adhesive agent delivers the optimal balance of adhesion to the surface and stickiness of the paint. Preferably the adhesive agent is a corn syrup or corn syrup solids, and most preferably a high fructose corn syrup.

The plasticizer is believed to promote flexibility and workability of the edible paint and further inhibits film brittleness. The plasticizer will generally be present in an amount of about 1% to about 50%, preferably about 2.5% to about 42.5%, more preferably about 5% to about 35%, even more preferably about 6% to about 27.5%, yet more preferably about 7% to about 20% and most preferably about 5% to about 15% by weight of the composition. The most preferred range of the plasticizer delivers optimal flexibility and viscosity of the edible paint. Preferably the plasticizer is selected from the group consisting of gum arabic, glycerin, propylene glycol, polyethylene glycol, triethylene glycol, fatty acids, glyceryl monoesters, acetylated monoglycerides, polyvinylpyrolidone and mixtures thereof. Most preferably the plasticizer is gum arabic.

The emulsifier is believed to provide compatibility by reducing surface tension between a fat-based substrate and the aqueous edible paint. An emulsifier consists of a polar group which has an affinity for the aqueous phase and a hydrocarbon group which is attracted to the fat substrate. The emulsifier acts to reduce the interfacial tension between the water and fat. The emulsifier will generally be present in an amount of about 0.05% to about 7%, preferably about 0.075 to about 5%, more preferably about 0.1% to about 3%, even more preferably about 0.5 to about 2.75%, yet more preferably about 1% to about 2.5%, and most preferably about 1.75 to about 2.25% by weight of the composition. The most preferred emulsifier range delivers the optimal balance of function, flavor and smoothness of the paint. Preferably, the emulsifier is selected from the group consisting of polyglycerol esters, polysorbates, glycerol monostearates, sorbitan monostearate, lecithin, mono- and di-glycerides, diacetyl tartaric acid esters of monoglycerides, polysorbate and sorbitan esters, propylene glycol esters and mixtures thereof. Preferably, the emulsifier is polyglycerol esters (e.g., Santone® 8-1-0 Octaglycerol Monooleate Emulsifier manufactured by LodersCroklaan, 24708 W. Durkee Road, Channahon Ill. 60410.). Polyglycerol esters are esters of fatty acids that are often made from edible oil sources such as cottonseed, corn, soybean, palm and peanut oils. The polyglycerol esters may be formed with mixtures of fatty acids from either natural or synthetic sources, or they may be formed with a single type fatty acid if desired, e.g., polyglycerol stearates, polyglycerol oleates, or polyglycerol ricinoleates. The ratio of the glycerol units to the fatty acid units forming the polyglycerol esters may also be varied as desired. Preferably the HLB (hydrophilic & lipophillic balance) value of the polyglycerol esters will be from about 7 to about 17, more preferably about 9-15 and most preferably about 11 to about 13.5. Polyglycerol esters for use in foods are readily available.

The colorant may be titanium dioxide, calcium carbonate or any other edible colorant (e.g., egg shell, rice starch, sea shell). In a preferred embodiment these are approved by the U.S. Food and Drug Administration. Titanium dioxide and/or calcium carbonate impacts the appearance of the paint in two ways; to provide opacity to the paint and to create pastel versions of the paint. Titanium dioxide is preferred. All FD&C certified or exempt from certification colorant permitted for use in food may be employed. In a preferred embodiment the colorant is a natural colorant (e.g., turmeric, beta carotene, carmine and caramel). Of course, mixtures of colorants are also included. Although both will work, pigments are preferred over dyes because they don't have the mouth staining concerns that dyes have when used at high concentration levels. In the U.S. a pigment is also referred to as a lake. Preferably, the colorant is present in an amount of about 0.01% to about 20%, preferably about 0.1% to about 15%, preferably about 0.5% to about 10% by weight of the composition. The most preferred range of colorant delivers the optimal finished paint color. Most preferably, when titanium dioxide is used as a colorant it should be added in the amount of about 1% to about 8% by weight of the composition.

The diluent serves to support the other functional components of the edible paint. As used herein, diluent includes solvents that may only partially dissolve one or more components in the composition or that do not necessarily dissolve all the components mixed therewith, i.e., there may be suspended material in the diluent such as titanium dioxide. Preferably the diluent is present in an amount of about 5% to about 80%, preferably about 12.5% to about 65%, more preferably about 15% to about 50%, most preferably about 20% to about 30% by weight of the composition. The preferred diluent is water. When water is used its preferred that it is demineralized water. The most preferred range of water provides the best overall balance of water activity and other physical properties like surface tension and viscosity. In another embodiment, the aqueous edible paint can be substantially dried to remove all of the moisture and provided to the customer in powdered form. The user could reconstitute to the desired final moisture, most preferably with water.

The edible paint composition of this invention preferably contains a humectant. The humectant serves to bind and/or absorb moisture and thereby decrease the water activity of the product. When present, the humectant is generally present in an amount of about 1% to about 80%, preferably about 10 to about 60%, and more preferably about 20% to about 50% by weight of the composition. The humectant may be selected from the group consisting of fructose, sorbitol and mixtures thereof. A reduced sugar composition would be possible by replacing fructose with sorbitol and a non-nutritive sweetener while maintaining a small amount of adhesive agent. Most preferably, the humectant is fructose. It should be apparent that the humectant may also serve to sweeten the edible paint composition.

While not required, it is desirable to maintain the water activity of the aqueous edible paint composition below 0.86 Aw in order to avoid the requirement of refrigeration, more preferably below 0.8 Aw and most preferably below 0.74 Aw. The preferred edible paint is shelf-stable at ambient conditions for about 30 weeks. This assists in maintaining the stability of the composition The long term stability of the aqueous edible paint composition is also buttressed by maintaining the pH of the composition between about 3 and about 6, preferably about 3.5 to about 5.0, and most preferably about 4.0 to about 4.5. In a preferred embodiment of this invention, this pH range can be achieved by adding a food-grade acid to the composition. Exemplary food-grade acids may be selected from the group consisting of citric acid, malic acid, maleic acid, tartaric acid, lactic acid, phosphoric acid and mixtures thereof. A particularly preferred food-grade acid is citric acid.

The aqueous paint composition should have a viscosity that allows the composition to be applied to an edible substrate in a controlled manner, i.e., the viscosity is not so low that the paint runs off the substrate or not so high that the paint is not easily painted. Rheological properties of edible paints may be determined in order to characterize the relationship between the paints' properties and their brushing performance.

The viscosity of all paint samples can be determined from the following equation:
η=k\dot{γ}⁽ⁿ⁻¹⁾
where η is the viscosity (Pas), k is the consistency index (Pasⁿ), γ is the shear rate (l/s), and n is the behavior index (dimensionless).

Generally, the steady-state shear viscosity of the composition, measured by means of rotational rheometry, will range from about 0.25 to about 20, preferably about 0.5 to about 15, and more preferably about 1.0 to about 10 and most preferred 1.5 to about 7.5 Pas at 0.1 l/s at 20° C.

The surface tension of the aqueous edible paint composition may be about 20 to about 65 dyne/cm, preferably about 25 to about 55 dyne/cm, and more preferably about 30 to about 52 dyne/cm. Generally, as the surface tension of the aqueous edible paint composition increases, the viscosity of the composition may be raised to counteract retraction from a fat-based edible substrate. Similarly, as the surface tension of the aqueous edible paint composition decreases, it may be preferable to reduce the viscosity of the composition since retraction is less of a problem.

The aqueous edible paint composition may also contain other edible additives, such as flavors (e.g., edible natural or natural/artificial flavors in liquid, spray dried or encapsulated form), preservatives (e.g., parabens, sodium benzoate or potassium sorbate), intense sweeteners (e.g., Sucralose) and thickeners (e.g. starches).

The aqueous edible paint composition of the invention is a water-based composition, i.e., at least 50% of diluent is water, preferably at least 75% of the diluent is water and more preferably at least 100% of the diluent is water. In a particularly preferred embodiment of the invention the composition is substantially free of solvents, i.e., less than about 2% solvents by weight of the composition.

Another embodiment of this invention is directed to a kit comprising at least one aqueous edible paint described above and an edible substrate. Preferably the edible substrate is fat-based and most preferably it is chocolate. As used herein, chocolate includes standard of identity (SOI) and non-SOI chocolates. Milk chocolate, dark chocolate and compound coatings are considered edible-fat based substrates. It should be apparent that the edible-fat based substrate may be a portion of a larger edible substrate, the other portions which may or may not be fat-based. Exemplary edible substrates for use in the kit of this invention include chocolate novelty products having holiday designs, chocolate bars or frames and a cookie with a chocolate area for painting. In another embodiment, the kit may optionally include small edible inclusions, e.g., sugar shelled candies, with a chocolate substrate having divets for which the edible paint could function as a glue to adhere small inclusions in the divets of the chocolate.

The kit may also include an applicator to assist in applying the aqueous edible paint to the edible substrate. The application may be a brush or foam piece. Of course, the aqueous edible paint may be applied directly from its container or by the fingers of the user. In addition, it is also possible to include additional decorative items with the kit, such as edible glitter (for example Spectra Flecks™ supplied by Sensient Food Colors, St. Louis, Mo.) or sprinkles that would be dropped or mixed into the wet paint. The edible glitter may also contain flavor(s). The kit may also include stamps which allow impressions to made in the wet aqueous edible paint.

Once the aqueous edible paint has been applied to the substrate of choice, the paint should be touchable within 1 hour of application in typical environmental conditions of 50RH and 70F. The drying time can be shortened when the RH of the ambient environment is less than 50% or a fan is used. Drying time can be further reduced by decreasing the fructose component of the formulation and replacing the fructose with water if desired.

Yet another embodiment of this invention is directed to a method of preparing the edible paint composition described herein. The method comprises the step of admixing: a) a film former in an amount of about 0.05 to about 10% by weight of the composition; b) an adhesive agent in an amount of about 0.05 to about 40% by weight of the composition; c) a plasticizer in an amount of about 1.0 to about 50% by weight of the composition; d) an emulsifier in an amount of about 0.05 to about 7% by weight of the composition; e) a colorant in an amount of about 0.01 to about 20% by weight of the composition; and f) a diluent in an amount of about 10% to about 70% by weight of the composition, so as to form the edible paint composition. In a particularly preferred embodiment, when the emulsifier is polyglycerol esters and the diluent is water, the step of admixing comprises separately heating (i) at least a portion of the water and (ii) the polyglycerol esters to a temperature of about 40° C. to about 60° C. and then mixing the heated water and polyglycerol esters. Even more preferably, the film former is hydroxypropyl cellulose and the hydroxypropyl cellulose is mixed with the heated water and polyglycerol esters.

In yet another preferred embodiment of preparing the edible paint composition, a food-grade acid is added to the admixture to bring the pH of the admixture to about 2 to about 6. As noted previously, the preferred food-grade acid is citric acid.

As previously mentioned, another embodiment of this invention includes drying the aqueous edible paint, e.g. spray or freeze drying, to form a powdered edible paint which is reconstituted with diluent prior to use. The powdered edible paint may be also substituted for the aqueous edible paint in the kit described herein.

### EXAMPLE 1

An edible paint composition was prepared using the ingredients shown in Table 1. First the demineralized (DM) water was heated to about 40° C. Then the polygylcerol esters was heated to about 55° C. to facilitate mixing and added to water. This heating step for both the water and polyglycerol esters is important to deliver a smooth composition free of clumps. The heated polyglycerol esters, the potassium sorbate and the hydroxypropyl cellulose were added to the heated water and mixed well in a benchtop blender for about ten minutes. Then the gum arabic and maltodextrin were slowly added to the mixture to prevent clumping. Next the colorants and flavor were added to the mixture, followed by mixing until a smooth consistent texture is achieved. A 50% citric acid in water solution was then added until a pH of about 4.5 was obtained. Over the course of mixing and ingredient addition the temperature increased to 55° C., but was not allowed to exceed 60° C.

The edible paint was then tested for viscosity, surface tension, water activity and adherence to chocolate. The results of these tests are set forth in Table II.

### EXAMPLES 2-7

Edible paint compositions were prepared using the ingredients shown in Table 1 in the same manner as described in Example 1. The edible paint compositions were tested and the results of those tests are set forth in Table 2.

### COMPARATIVE EXAMPLES 1-3

Edible paint compositions were prepared by admixing the ingredients shown in Table 1. The edible paint compositions were tested and the results of those tests are set forth in Table 2. Each of the comparative examples is missing one or more functional ingredients. Comparative Example 1 does not contain the film former or emulsifier. Comparative Example 2 does not contain the emulsifier. Comparative Example 3 does not contain the film former.

TABLE 1

| | | | | | | | | Comp | Comp | Comp |
|---|---|---|---|---|---|---|---|---|---|---|
| INGREDIENTS | Ex. 1 | Ex. 2 | Ex. 3 | Ex. 4 | Ex. 5 | Ex. 6 | Ex. 7 | Ex. 1 | Ex. 2 | Ex. 3 |
| Water (DM) | 26.0 | 22.0 | 28.56 | 43.45 | 50.75 | 42.35 | 50 | 44.67 | 43.32 | 43.32 |
| Hydroxypropyl Cellulose | 1.0 | 1.0 | 1.0 | 1.0 | 1.0 | 0.1 | 1.0 | — | 0.1 | — |
| Potassium Sorbate | 0.12 | 1.5 | 1.5 | 1.5 | 1.5 | — | — | — | 2.0 | 2.0 |
| Maltodextrin | 10 | 5 | 11 | 11 | 11 | 10 | — | 10.42 | 10.42 | 10.42 |
| Gum Arabic | 10 | 15 | 25 | 25 | 18 | 17 | 22.5 | 17.7 | 17.7 | 17.7 |
| Sorbitol Soln 70% USP | — | 4 | 4 | 4 | 4 | 2 | — | — | — | — |
| Polyglycerol Esters | 1.5 | 2 | 2 | 2 | 2.5 | 1 | 1.5 | — | — | 0.1 |
| High Fructose Corn Syrup | 2.5 | 5 | 5 | 5 | 5 | 10 | 10 | 10.42 | 10.42 | 10.42 |
| FD&C Aluminum Lake | — | 0.67 | 0.69 | 0.69 | 0.69 | 0.83 | — | 0.79 | 1.83 | 1.83 |
| Titanium Dioxide | 5.63 | 5.63 | 5.63 | 5.63 | 4.94 | 15.59 | 15 | 14.83 | 13.17 | 13.7 |
| Sucralose Powder | — | — | 0.02 | 0.02 | 0.02 | — | — | — | — | — |
| Flavor | 0.6 | 0.6 | 0.6 | 0.6 | 0.6 | — | — | — | — | — |
| Parabens | — | — | — | — | — | 0.13 | — | 0.13 | — | — |
| Propylene Glycol | — | — | — | — | — | 1 | — | 1.04 | 1.04 | 1.04 |
| Glycerine (99%) | — | 5.0 | 15.0 | — | — | — | — | — | — | — |
| Citric Acid | * | — | — | — | — | — | — | — | — | — |
| Fructose | 42.64 | 32.48 | — | — | — | — | — | — | — | — |

* Titrated with 50% aqueous citric acid solution to a pH of 4.5.

TABLE 2

| | | | | | | | | Comp | Comp | Comp |
|---|---|---|---|---|---|---|---|---|---|---|
| Test | Ex. 1 | Ex. 2 | Ex. 3 | Ex. 4 | Ex. 5 | Ex. 6 | Ex. 7 | Ex. 1 | Ex. 2 | Ex. 3 |
| Viscosity | 6.812 | — | — | — | --1.562 | 15.244 | — | — | — | — |
| (Pas at 0.1 l/s at 20° C.) | | | | | | | | | | |
| Surface Tension | 51 | — | — | — | 39.75 | 42.8 | — | 62.38 | — | — |
| (dyne/cm) | | | | | | | | | | |
| Water Activity | 0.74 | 0.72 | 0.84 | 0.96 | 0.96 | 0.96 | — | 0.97 | — | — |
| Retraction | None | None | None | None | Slight | None | None | Strong | Strong | Strong |
| Cracking/Peeling after 24 hours | No | No | No | No | No | No | None | Yes | — | — |
| Drying Time greater than 30 minutes | Yes | Yes | No | No | No | No | No | No | — | — |
| Adherence | Good | Good | Good | Good | Good | Good | Good | Fair | Poor | Poor |

What is claimed is:

1. An aqueous edible paint composition comprising:
a) a film former in an amount of about 0.05 to about 10% by weight of the composition;
b) an adhesive agent in an amount of about 0.5 to about 40% by weight of the composition;
c) a plasticizer in an amount of about 1.0 to about 50% by weight of the composition;
d) an emulsifier in an amount of about 0.05 to about 7% by weight of the composition;
e) a colorant in an amount of about 0.01 to about 20% by weight of the composition; and
f) a diluent in an amount of about 5% to about 80% by weight of the composition.

2. The edible paint composition of claim 1, wherein (i) the film former is a cellulose based edible compound, (ii) the adhesive agent is selected from the group consisting of a corn syrup, corn syrup solids, maltodextrin and mixtures thereof, (iii) the plasticizer is selected from the group consisting of gum arabic, glycerin, propylene glycol, polyethylene glycol, triethylene glycol, fatty acids, glyceryl monoesters, acetylated monoglycerides, polyvinylpyrolidone and mixtures thereof, (iv) the emulsifier is selected from the group consisting of polyglycerol esters, polysorbates, glycerol monosterates, sorbitan mono-stearate, lecithin, mono- and di-glycerides, diacetyl tartaric acid esters of monoglycerides, polysorbate and sorbitan esters, propylene glycol esters and mixtures thereof, and (v) the diluent is water.

3. The edible paint composition of claim 1, wherein the colorant is selected from the group consisting of edible pigments, dyes, natural colors, titanium dioxide and mixtures thereof.

4. The edible paint composition of claim 1, further comprising a humectant in an amount of about 1% to about 80% by weight of the composition.

5. The edible paint composition of claim 1, wherein the surface tension of the paint composition is about 20 to about 65 dyne/cm and the viscosity of the composition is in a range of from about 0.25 to about 20 Pas at 0.1 l/s at 20° C.

6. The edible paint composition of claim 1, wherein the water activity of the composition is less than about 0.8.

7. The edible paint composition of claim 1, wherein the pH of the composition is about 3 to about 6.

8. A method of preparing an edible paint composition comprising the step of admixing:
a) a film former in an amount of about 0.05 to about 10% by weight of the composition;
b) an adhesive agent in an amount of about 0.5 to about 40% by weight of the composition;
c) a plasticizer in an amount of about 1.0 to about 50% by weight of the composition;
d) an emulsifier in an amount of about 0.05 to about 7% by weight of the composition;
e) a colorant in an amount of about 0.01 to about 20% by weight of the composition; and
f) a diluent in an amount of about 5% to about 80% by weight of the composition, to form the edible paint composition.

9. The method of claim 8, wherein (i) the film former is a cellulose based edible compound, (ii) the adhesive agent is selected from the group consisting of a corn syrup, corn syrup solids and mixtures thereof, (iii) the plasticizer is selected from the group consisting of gum arabic, glycerin, propylene glycol, polyethylene glycol, triethylene glycol, fatty acids, glycerol monoesters, acetylated monoglycerides, polyvinylpyrolidone and mixtures thereof, and (iv) the emulsifier is selected from the group consisting of polyglycerol esters, polysorbates, glycerol monosterates, sorbitan monostearate, lecithin, mono- and di-glycerides, diacetyl tartaric acid esters of monoglycerides, polysorbate and sorbitan esters, propylene glycerol esters and mixtures thereof.

10. The method of claim 8, wherein the colorant is selected from the group consisting of edible pigments, dyes, natural colors, titanium dioxide, calcium carbonate and mixtures thereof.

11. The method of claim 8, further comprising the step admixing a humectant in an amount of about 1% to about 80% by weight of the composition.

12. An edible paint and eat kit comprising:
(i) at least one aqueous edible paint composition comprising:
a) a film former in an amount of about 0.05 to about 10% by weight of the composition;
b) an adhesive agent in an amount of about 0.5 to about 40% by weight of the composition;
c) a plasticizer in an amount of about 1.0 to about 50% by weight of the composition;
d) an emulsifier in an amount of about 0.05 to about 7% by weight of the composition;
e) a colorant in an amount of about 0.01 to about 20% by weight of the composition; and
f) a diluent in an amount of about 5% to about 80% by weight of the composition; and
(ii) an edible substrate.
